(19) United States
(12) Patent Application Publication
(10) Pub. No.: US 2025/0196118 A1
(43) Pub. Date: Jun. 19, 2025

(54) Exhaust Gas Purification Catalyst

(71) Applicant: Cataler Corporation, Kakegawa-Shi (JP)

(72) Inventors: Akiya Chiba, Kakegawa-Shi (JP); Ryoichi Ogawa, Kakegawa-Shi (JP); Yuki Kawakami, Kakegawa-Shi (JP); Hiroto Imai, Kakegawa-Shi (JP)

(21) Appl. No.: 18/728,530

(22) PCT Filed: Aug. 30, 2022
(86) PCT No.: PCT/JP2022/032625

§ 371 Date: Jul. 12, 2024

(30) Foreign Application Priority Data
Jan. 21, 2022 (JP) 2022-007563

(51) Int. Cl. B01J 35/00; B01D 53/94; B01J 23/42; B01J 23/44; B01J 23/46; B01J 29/83

(52) U.S. Cl. CPC B01J 35/19; B01D 53/944; B01J 23/42; B01J 23/44; B01J 23/464; B01J 29/83

(57) ABSTRACT

The present invention provides an exhaust gas purification catalyst having high exhaust gas purification performance at cold start after the hydrothermal durability treatment. The exhaust gas purification catalyst disclosed herein includes a base material and a catalyst layer provided on the base material. The catalyst layer includes a catalyst metal and a hydrocarbon adsorption material. The hydrocarbon adsorption material contains 80 mass % or more of molecular sieve substantially containing no Si.

### TECHNICAL FIELD

The present invention relates to an exhaust gas purification catalyst. The present application is based upon and claims the benefit of priority from Japanese patent application No. 2022-007563 filed on Jan. 21, 2022, and the entire disclosure of which is incorporated herein its entirety by reference.

### BACKGROUND ART

The exhaust gas exhausted from the internal combustion engine such as an automobile engine contains harmful components such as hydrocarbon (HC), carbon monoxide (CO), and nitrogen oxide (NOx). In order to efficiently react and remove these harmful components from the exhaust gas, an exhaust gas purification catalyst has been used. One typical configuration of the exhaust gas purification catalyst is one in which a catalyst layer containing a catalyst metal such as platinum (Pt), palladium (Pd), or rhodium (Rh) is formed on a highly heat-resistant base material such as ceramics.

In the state where the exhaust gas purification catalyst immediately after engine startup is not sufficiently heated (so-called cold start), it is difficult to obtain sufficient catalytic activity for the treatment of hydrocarbon (HC) due to the low temperature of the exhaust gas purification catalyst. For this reason, a technology is known in which HC purification treatment is performed by allowing an HC adsorption material to be contained in a catalyst layer, causing the HC adsorption material to adsorb HC at low temperatures where catalytic activity is insufficient, and releasing the HC at temperatures where catalytic activity is sufficient (see, for example, Patent Literatures 1 to 5). Various types of zeolites are commonly used as the HC adsorption material, as described in Patent Literatures 1 to 5.

### CITATION LIST

### Patent Literatures

Patent Literature 1: Japanese Patent Application Publication No. H7-256114
Patent Literature 2: Japanese Patent Application Publication No. H11-179158
Patent Literature 3: Japanese Patent Application Publication No. 2000-51707
Patent Literature 4: Japanese Patent Application Publication No. 2001-79423
Patent Literature 5: Japanese Patent Application Publication No. 2003-290661

### SUMMARY OF INVENTION

### Technical Problem

In recent years, further tightening of exhaust gas regulations has required the exhaust gas purification catalyst to have higher removal performance of harmful components contained in exhaust gas. For example, higher exhaust gas purification performance at cold start is required. As a result of earnest studies, the present inventors have found as follows. The prior art exhaust gas purification catalyst using zeolite has a problem in that the purifying performance at cold start is significantly degraded after exposure to high-temperature exhaust gas containing water for a long period of time (i.e., after hydrothermal durability treatment).

The present invention was made in view of the circumstances described above, and is intended to provide an exhaust gas purification catalyst having a high exhaust gas purification performance at cold start after the hydrothermal durability treatment. Solution to Problem

As a result of earnest studies, the present inventors have found as follows. The significant degradation in purifying performance after the hydrothermal durability treatment in the prior art exhaust gas purification catalyst using zeolite is caused by migration of Si contained in the zeolite (aluminosilicate salt) during the hydrothermal durability treatment and an adverse effect of the migration on a noble metal which is a catalyst metal. Further, use of molecular sieve substantially containing no Si at a predetermined ratio or more as the HC adsorption material drastically and significantly increases the purifying performance of the exhaust gas purification catalyst at cold start after the hydrothermal durability treatment.

The exhaust gas purification catalyst disclosed herein includes a base material and a catalyst layer provided on the base material. The catalyst layer includes a catalyst metal and a hydrocarbon adsorption material. The hydrocarbon adsorption material contains 80 mass % or more of molecular sieve substantially free from Si. With such a configuration, an exhaust gas purification catalyst having a high purifying performance at cold start after the hydrothermal durability treatment can be provided.

In a preferred aspect of the exhaust gas purification catalyst disclosed herein, the hydrocarbon adsorption material contains 90 mass % or more of the molecular sieve substantially free from Si. With such a configuration, an exhaust gas purification catalyst having a higher purifying performance at cold start after the hydrothermal durability treatment can be provided.

The molecular sieve substantially free from Si is suitably an aluminophosphate molecular sieve. It is advantageous that the aluminophosphate molecular sieve has a framework structure of AFI type.

In a preferred aspect of the exhaust gas purification catalyst disclosed herein, the catalyst layer includes a first portion catalyst layer formed on a surface of the base material and including the catalyst metal, and a second portion catalyst layer formed on the first portion catalyst layer and including the catalyst metal being different in type from the catalyst metal of the first portion catalyst layer. The first portion catalyst layer includes, as the catalyst metal, an oxidation catalyst. The second catalyst layer includes, as the catalyst metal, a reduction catalyst. With such a configuration, the exhaust gas purification catalyst having particularly excellent exhaust gas purification performance can be provided. In light of higher exhaust gas purification performance, it is advantageous that the first portion catalyst layer includes, as the catalyst metal, Pt, and the second portion catalyst layer includes, as the catalyst metal, Rh. Such a case is particularly advantageous for paraffin purification. Alternatively, in light of higher exhaust gas purification performance, it is advantageous that the first portion catalyst layer includes, as the catalyst metal, Pd, and the second portion catalyst layer includes, as the catalyst metal, Rh. Such a case is particularly advantageous for olefin purification.

### BRIEF DESCRIPTION OF DRAWINGS

FIG. 1 is a schematic view of an exhaust gas purification system according to a first embodiment.

FIG. 1 is a schematic perspective view of an exhaust gas purification catalyst of FIG. 1.

FIG. 3 is a partial cross-sectional view of a portion of the exhaust gas purification catalyst of FIG. 1, cut in a cylinder axis direction.

FIG. 4 is a partial cross-sectional view of a configuration of a variation of the exhaust gas purification catalyst of FIG. 1.

FIG. 5 is a graph plotting HC 50% purification temperature after hydrothermal durability treatment for each Example and each Comparative Example.

### DESCRIPTION OF EMBODIMENTS

### First Embodiment

Some preferred embodiments of the present invention will be described below with reference to the accompanying drawings. The matters which are not specifically mentioned in the present specification and are necessary for implementation of the present invention can be understood as design matters of those skilled in the art based on the conventional art in the field. The present invention can be carried out based on the contents disclosed herein and the technical knowledge in the present field. In the following drawings, the same members/portions which exhibit the same action are denoted by the same reference numerals, and the duplicated descriptions may be omitted or simplified. The dimensional relation (such as length, width, or thickness) in each drawing may not necessarily reflect the actual dimensional relation. The expression “A to B” (A and B are any numerical values) indicating herein a range means A or more to B or less, and also encompasses the meaning of “preferably more than A” and “preferably less than B.”

### Exhaust Gas Purification System

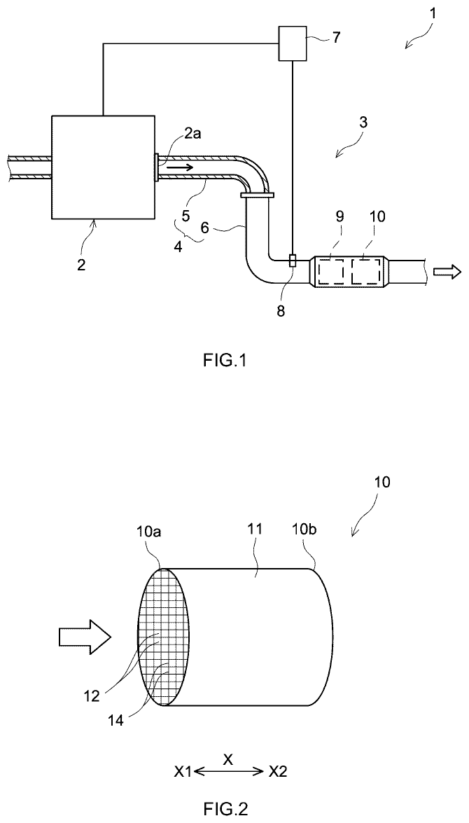

FIG. 1 is a schematic view of an exhaust gas purification system 1. The exhaust gas purification system 1 includes an internal combustion engine (engine) 2, an exhaust gas purification device 3, and an engine control unit (ECU) 7. The exhaust gas purification system 1 is configured to purity, in the exhaust gas purification device 3, harmful components such as HC, CO, and NOx contained in exhaust gas exhausted from the internal combustion engine 2. It should be noted that the arrow in FIG. 1 represents an exhaust gas flow direction. Further, in the following description, along the flow of the exhaust gas, the side near the internal combustion engine 2 is referred to as an upstream side, and the side farther from the internal combustion engine 2 is referred to as a downstream side.

The internal combustion engine 2 mainly includes a gasoline engine of a gasoline-powered vehicle. The internal combustion engine 2 may be an engine other than the gasoline engine, such as a diesel engine or an engine in a hybrid vehicle. The internal combustion engine 2 includes a combustion chamber (not shown). The combustion chamber is in connection to a fuel tank (not shown). The fuel tank stores gasoline in this case. However, the fuel stored in the fuel tank may be diesel fuel (light oil), and the like. In the combustion chamber, fuel supplied from the fuel tank is mixed with oxygen, and the mixture is then burned. This converts combustion energy into mechanical energy. The combustion chamber is in communication with an exhaust port 2a. The exhaust port 2a is in communication with the exhaust gas purification device 3. The combusted fuel gas is exhausted into the exhaust gas purification device 3 as exhaust gas.

The exhaust gas purification device 3 includes an exhaust path 4 in communication with the internal combustion engine 2, a pressure sensor 8, a first catalyst 9, and a second catalyst 10. The exhaust path 4 is an exhaust gas path through which exhaust gas flows. The exhaust path 4 includes an exhaust manifold 5 and an exhaust pipe 6. An end of the exhaust manifold 5 at the upstream side is in connection to the exhaust port 2a of the internal combustion engine 2. An end of the exhaust manifold 5 at the downstream side is in connection to the exhaust pipe 6. In the middle of the exhaust pipe 6, the first catalyst 9 and the second catalyst 10 are placed in order from the upstream side. Note that the placement of the first catalyst 9 and the second catalyst 10 can be changed, as appropriate. The number of the first catalysts 9 and the second catalysts 10 is not particularly limited, and may be multiple. A third catalyst may further be placed on the downstream side of the second catalyst 10.

The first catalyst 9 may be the same as conventional one and is not particularly limited. Examples of the first catalyst 9 include: a diesel particulate filter (DPF) that removes PM contained in exhaust gas: a diesel oxidation catalyst (DOC) that purifies HC and CO contained in exhaust gas: a three-way catalyst that purifies HC, CO, and NOx contained in exhaust gas in parallel: and an NOx storage reduction (NSR) catalyst that stores NOx during normal operation (under lean conditions) and purifying NOx by using HC and CO as reductants when more fuel is injected (in a rich atmosphere). The first catalyst 9 may have a function to increase the temperature of the exhaust gas flowing into the second catalyst 10, for example. Note that the first catalyst 9 is not essential, and may be omitted in other embodiments.

The second catalyst 10 has a function of purifying harmful components (e.g., HC) in exhaust gas. The second catalyst 10 herein is a three-way catalyst. The second catalyst 10 is an example of the exhaust gas purification catalyst disclosed herein. It should be noted that hereinafter, the second catalyst 10 may also be referred to as an “exhaust gas purification catalyst.” The configuration of the second catalyst (exhaust gas purification catalyst) 10 will be described in detail below.

The ECU 7 controls the internal combustion engine 2 and the exhaust gas purification device 3. The ECU 7 is electrically connected to sensors (e.g., a pressure sensor 8, a temperature sensor, and an oxygen sensor) installed in each of parts of the internal combustion engine 2 and the exhaust gas purification device 3. It should be noted that the configuration of the ECU 7 may be the same as known one and is not particularly limited. The ECU 7 may be, for example, a processor or an integrated circuit. ECU 7 has an input port (not shown) and an output port (not shown). The ECU 7 receives information on the operating state of the vehicle and the amount, temperature, and pressure of the exhaust gas exhausted from the internal combustion engine 2, for example. The ECU 7 receives the information detected by the sensors (e.g., the pressure measured by the pressure sensor 8) via the input port. The ECU 7 transmits a control signal via an output port based on information received, for example. The ECU 7 controls, for example, operation such as fuel injection control and fuel ignition control of the internal combustion engine 2, and intake air volume control. The ECU 7 controls driving and stopping of the exhaust gas purification device 3 on the basis of the operating state of the internal combustion engine 2, the amount of exhaust gas exhausted from the internal combustion engine 2, and the like.

### Exhaust Gas Purification Catalyst

FIG. 2 is a schematic perspective view of the exhaust gas purification catalyst 10. It should be noted that the arrow in FIG. 2 represents an exhaust gas flow direction. In FIG.

2, the upstream side of the exhaust path 4 relatively close to the internal combustion engine 2 is represented on the left, and the downstream side of the exhaust path relatively far from the internal combustion engine 2 is represented on the right. In FIG. 2, the reference sign X represents the cylinder axis direction of the exhaust gas purification catalyst 10. The exhaust gas purification catalyst 10 is placed in the exhaust path 4 such that the cylinder axis direction X is along the exhaust gas flow direction. The cylinder axis direction X is an exhaust gas flowing direction. Hereinafter, in the cylinder axis direction X, a side toward one direction X1 may be referred to as the upstream side (the exhaust gas inflow side, the front side), and a side toward the other direction X2 may be referred to as the downstream side (the exhaust gas outflow side, the rear side). Such directions are defined for convenience of explanation and are not intended to limit the installation form of the exhaust gas purification catalyst 10.

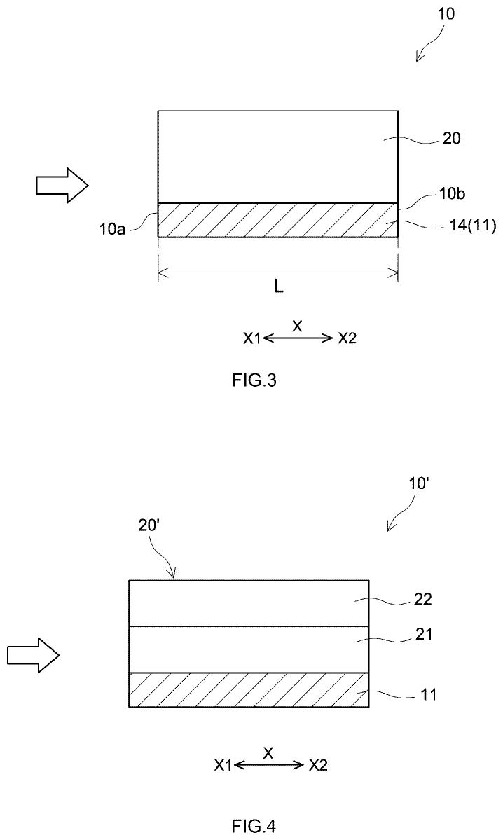

The exhaust gas purification catalyst 10 includes a base material 11 having a straight flow structure and a catalyst layer 20 (see FIG. 3). The end of the exhaust gas purification catalyst 10 in one direction X1 is the inlet 10a for the exhaust gas, and the end of the same in the other direction X2 is the outlet 10b for the exhaust gas. The outer shape of the exhaust gas purification catalyst 10 herein is cylindrical. The outer shape of the exhaust gas purification catalyst 10 is not particularly limited, and examples thereof include an elliptic cylindrical shape, a polygonal cylindrical shape, a pipe shape, a foam shape, a pellet shape, a fiber shape.

The base material 11 forms the framework of the exhaust gas purification catalyst 10. The base material 11 is not particularly limited, and can employ various materials and forms conventionally for use in this kind of use. The base material 11 may be a ceramics carrier made of ceramics such as cordierite, aluminum titanate, and silicon carbide or a metal carrier made of stainless steel (SUS), a Fe—Cr—Al alloy, a Ni—Cr—Al alloy, and the like. As illustrated in FIG. 2, here, the base material 11 has a honeycomb structure. The base material 11 includes multiple cells (hollows) 12 regularly arranged in the cylinder axis direction X, and partitions (ribs) 14 partitioning the cells 12. Although not particularly limited thereto, the volume of the base material 11 (the apparent volume including the volume of the cells 12) may be approximately 0.1 L to 10 L, for example, about 0.5 L to about 5 L. The average length (full length) L of the base material 11 along the cylinder axis direction X may be approximately 10 mm to 500 mm, for example, 50 mm to 300 mm.

The cells 12 each form an exhaust gas passage. The cell 12 extends in the cylinder axis direction X. The cell 12 is a through hole passing through the base material 11 in the cylinder axis direction X. The shape, size, number, and the like of the cell 12 can be designed in consideration of the flow rate and components of the exhaust gas flowing through the exhaust gas purification catalyst 10, for example. The cross-sectional shape of the cell 12 orthogonal to the cylinder axis direction X is not particularly limited. The cross-sectional shape of the cell 12 may be, for example, any of various geometric shapes, namely a quadrilateral such as square, parallelogram, rectangle, trapezoid: other polygons (e.g., triangle, hexagonal, octagonal); corrugate, and circular. The partitions 14 face the cells 12 and each partitions adjacent cells 12. Although not particularly limited thereto, the average thickness of each partition 14 (the dimension of each partition 14 in the direction orthogonal to its surface, hereinafter the same) may be approximately 0.1 mil to 10 mil (1 mil=about 25.4 μm), for example, about 0.2 mil to about 5 mil, to improve mechanical strength and reduce pressure drop. The partition 14 may be porous to allow the exhaust gas to pass therethrough.

The catalyst layer 20 is a reaction field where exhaust gas is purified. The catalyst layer 20 is a porous body having many pores (voids). The exhaust gas flowing into the exhaust gas purification catalyst 10 comes into contact with the catalyst layer 20 while flowing through the passages (cells 12) in the exhaust gas purification catalyst 10. In this manner, harmful components in the exhaust gas are purified. For example, HC and CO contained in the exhaust gas are oxidized by the catalyst layer 20, thereby converted (purified) into water, carbon dioxide, and the like. For example, NOx is reduced by the catalyst layer 20, thereby converted (purified) into nitrogen.

FIG. 3 is a schematic partial cross-sectional view of a portion of the exhaust gas purification catalyst 10 cut along the cylinder axis direction X. The catalyst layer 20 is provided on the base material 11, specifically on the surfaces of the partitions 14. However, the catalyst layer 20 may partially or fully penetrate into the partitions 14.

The catalyst layer 20 contains at least a catalyst metal and hydrocarbon (HC) adsorption material. The catalyst metal and hydrocarbon (HC) adsorption material are essential components of the catalyst layer 20.

As the catalyst metal, various metal species that can function as an oxidation catalyst or a reduction catalyst for purification of harmful components can be used. Typical examples of the catalyst metal include platinum group metals, namely rhodium (Rh), palladium (Pd), platinum (Pt), ruthenium (Ru), osmium (Os), and iridium (Ir). In place of or in addition to the platinum group metals, other metal species may be used. For example, metal species such as iron (Fe), cobalt (Co), nickel (Ni), copper (Cu), silver (Ag), and gold (Au) may also be used. Alloys of two or more kinds of these metals may also be used. Among them, the catalyst metal is suitably an oxidation catalyst (e.g., at least one of Pd or Pt) having high oxidation activity and a reduction catalyst (e.g., Rh) having high reduction activity, and is particularly preferably a combination of two or more kinds of them. The oxidation catalyst and the reduction catalyst may be present in the same (single) catalyst layer or different catalyst layers.

The catalyst metal used is preferably in a form of fine particles having sufficiently small particle diameters from a viewpoint of increasing contact area with exhaust gas. The mean particle diameter of the catalyst metal (a mean value of particle diameters of 50 or more particles of the catalyst metal determined by observation with a transmission electron microscope (TEM)) may be approximately 1 nm to 15 nm, for example, 10 nm or less, further 5 nm or less.

The amount of the catalyst metal in the exhaust gas purification catalyst 10 is not particularly limited, and can be determined appropriately according to the kind of the catalyst metal. In terms of particularly high exhaust gas purification performance, the amount of the catalyst metal per 1 L of the volume of the base material 11 may be, for example, 0.01 g/L or more, 0.03 g/L or more, 0.05 g/L or more, 0.08 g/L or more, or 0.10 g/L or more. In terms of balance between the exhaust gas purification performance and the cost, the amount may be, for example, 15.00 g/L or less, 10.00 g/L or less, 5.00 g/L or less, 3.00 g/L or less, 1.50 g/L or less, 1.00 g/L or less, 0.80 g/L or less, or 0.50 g/L or less.

It should be noted that “per 1 L of volume of the base material” herein refers to per 1 L of bulk volume including the pure volume of the base material and the volume of the cell passages. In the following description, the term “(g/L)” refers to the amount contained in 1 L of the volume of the base material.

In the present embodiment, the HC adsorption material contained in the catalyst layer 20 contains 80 mass % or more of molecular sieve substantially free from Si. In other words, the mass proportion of the molecular sieve substantially free from Si relative to the total mass of the HC adsorption material contained in the catalyst layer 20 is 80 mass % or higher.

In the prior art, the catalyst layer contains zeolite as an HC adsorption material. Zeolite is crystalline aluminosilicate which functions as a molecular sieve and thus contains Si and Al. According to the findings by the present inventors, when the catalyst layer containing zeolite is subjected to the hydrothermal durability treatment, Si contained in the zeolite is migrated, which causes an adverse effect on the noble metal which is the catalyst metal, thereby degrading the exhaust gas purification performance at cold start. This is considered to be due to the reduction of SiO₂ contained in the zeolite to SiO in a high-temperature reducing atmosphere, resulting in interfacial migration and evaporation in the form of SiOx. This is also considered to be due to poisoning by the interaction between Si and the noble metal.

As a result of studies, the present inventors have found as follows. As can be seen from the results of Examples and Comparative Examples to be described later, when 80 mass % or more of molecular sieve substantially containing no Si is used as the HC adsorption material, the purifying performance at cold start after the hydrothermal durability treatment is drastically improved. Thus, in the present embodiment, by allowing the HC adsorption material to contain 80 mass % or more of molecular sieve substantially free from Si, the decrease in purifying performance at cold start after the hydrothermal durability treatment can be substantially prevented.

The expression “a molecular sieve substantially free from Si” herein means that the proportion of Si atoms in all atoms constituting the molecular sieve is 6 atom % or less (preferably 3 atom % or less, more preferably 1 atom % or less, yet more preferably 0 atom % or less). Therefore, it is acceptable for Si to be contained in the molecular sieve due to, for example, Si migration, inevitable impurities, and the like. It should be noted that The proportion of Si atoms in all atoms constituting the molecular sieve can be determined by X-ray fluorescence analysis (XRF).

The molecular sieve substantially free from Si is not particularly limited as long as having an HC adsorption capacity, and is preferably aluminophosphate (ALPO) molecular sieve. The aluminophosphate molecular sieve may be aluminophosphate (AlPO₄) having a framework structure which is the same, similar, or different from zeolite. Although the ALPO molecular sieve is substantially free from Si, the SiO₂/Al₂O₃ ratio (molar ratio) in the ALPO molecular sieve is preferably less than 1, more preferably 0.5 or less, yet more preferably 0.1 or less, most preferably 0. The ALPO molecular sieve used herein is substantially free from Si, and thus is different from aluminophosphate-based zeolite having a high content ratio of Al₂O₃ to SiO₂ (even in low silica zeolite, the SiO₂/Al₂O₃ ratio is generally 1 or more). It should be noted that the SiO₂/Al₂O₃ ratio can be determined by X-ray fluorescence analysis (XRF).

As the ALPO molecular sieve, those having various framework structures are known, and examples of the framework structures include AEI, AEL, AEN, AET, AFI, AFN, AFO, AFR, AFS, AFT, AFY, ANA, APC, APD, AST, ATO, ATS, ATT, ATV, AVE, AVL, AWO, AWW, CHA, DFO, ERI, LEV, SBS, SBE, SBT, SOD, VFI, and ZON as framework type codes determined by International Zeolite Association (IZA). The ALPO molecular sieve is of preferably AFI type because of having a particularly high purifying performance at cold start after the hydrothermal durability treatment.

The HC adsorption material included in the catalyst layer 20 contains preferably 90 mass % or more, more preferably 95 mass % or more, yet more preferably 97 mass % or more, most preferably 100 mass % of the molecular sieve substantially free from Si because the purifying performance at cold start after the hydrothermal durability treatment becomes higher.

When the HC adsorption material contains not less than 80 mass % but less than 100 mass % of the molecular sieve substantially free from Si, the HC adsorption material contains an adsorption material (also referred to as “other HC adsorption material”) other than the molecular sieve substantially free from Si. The other HC adsorption material may be zeolite. The zeolite may be known zeolite used as the HC adsorption material of gas purification catalysts. The HC adsorption material contained in the catalyst layer 20 may contain, for example, more than 0 mass %, 1 mass % or more, or 3 mass % or more of the zeolite, or 20 mass % or less, 10 mass % or less, 5 mass % or less, or 3 mass % or less of the zeolite.

The amount of the HC adsorption material in the exhaust gas purification catalyst 10 is not particularly limited, and can be designed, as appropriate, considering the size of the cells 12 of the base material 11, the flow rate of exhaust gas flowing through the exhaust gas purification catalyst 10, and the like. The amount of the HC adsorption material per 1 L of the volume of the base material 11 is, for example, 1 g/L or more, 5 g/L or more, 10 g/L or more, 15 g/L or more, or 20 g/L or more, and for example, 200 g/L or less, 150 g/L or less, 100 g/L or less, 80 g/L or less, 60 g/L or less, 50 g/L or less, or 40 g/L or less.

The catalyst metal may be carried on the HC adsorption material or a carrier. Thus, the catalyst layer 20 may further contain a carrier for carrying the catalyst metal. The catalyst metal may be carried on either one or both of the HC adsorption material and the carrier.

The carrier for carrying the catalyst metal can be a known material used as a carrier for the catalyst metal of the exhaust gas purification catalyst. The carrier is typically an inorganic porous body. Examples of the carrier include: a material (non-OSC material) having no oxygen storage capacity such as aluminum oxide (Al₂O₃, alumina), titanium oxide (TiO₂, titania), zirconium oxide (ZrO₂, zirconia), and silicon oxide (SiO₂, silica); and a material (OSC material) having an oxygen storage capacity such as ceria (CeO₂) and composite oxides containing ceria. The carrier may be either one or both of the non-OSC material and the OSC material.

In order to improve heat resistance, the oxide used as the non-OSC material may contain oxide of rare-earth element such as Pr₂O₃, Nd₂O₃, La₂O₃, and Y₂O₃ in a small amount (e.g., from 1 mass % to 10 mass %). The non-OSC material is preferably Al₂O₃, more preferably La₂O₃-composited Al₂O₃ (La₂O₃—A1₂O₃ composite oxide: LA composite oxide) because of having particularly high heat resistance and durability.

For the OSC material, the composite oxide containing ceria can be a composite oxide containing ceria and zirconia (ceria-zirconia composite oxide (so-called CZ composite oxide or ZC composite oxide). When the OSC material contains zirconium oxide, thermal degradation of the cerium oxide can be prevented. Thus, the OSC material is preferably ceria-zirconia composite oxide.

The OSC material may contain an oxide of rare-earth element in order to improve characteristics (particularly, heat resistance and oxygen storage-release characteristics). Examples of the rare-earth element include Sc, Y, La, Pr, Nd, Pm, Sm, Eu, Gd, Tb, Dy, Ho, Er, Tm, Yb, and Lu. The oxide of the rare-earth element is suitably Pr₂O₃, Nd₂O₃, La₂O₃, or Y₂O₃.

In the case where the OSC material is a composite oxide containing cerium oxide, from a viewpoint of sufficiently exhibiting its oxygen storage capacity, the content of the cerium oxide is preferably 15 mass % or more, more preferably 20 mass % or more. When the content of cerium oxide is too high, the basicity of the OSC material may be too high. Thus, the content of the cerium oxide is preferably 40 mass % or less, more preferably 30 mass % or less.

As an example, the catalyst layer 20 includes the HC adsorption material, the OSC material, and the non-OSC material, and the catalyst metal is carried on all of the HC adsorption material, the OSC material, and the non-OSC material.

The catalyst layer 20 may further contain the OSC material and/or the non-OSC material in the form of not carrying the catalyst metal. The OSC material and the non-OSC material used as carriers and the OSC material and the non-OSC material used as non-carriers preferably do not contain Si.

The amounts of the OSC material and the non-OSC material in the exhaust gas purification catalyst 10 are not particularly limited, and can be designed, as appropriate, considering the size of the cells 12 of the base material 11, the flow rate of exhaust gas flowing through the exhaust gas purification catalyst 10, and the like. The total amount of the OSC material and the non-OSC material per 1 L of the volume of the base material 11 (the total amount of the OSC material and the non-OSC material as carriers and non-carriers) may be, for example, 50 g/L or more, 70 g/L or more, 80 g/L or more, 90 g/L or more, or 100 g/L or more, and for example, 300 g/L or less, 250 g/L or less, 200 g/L or less, 180 g/L or less, or 160 g/L or less.

The catalyst layer 20 preferably contains the OSC material as a carrier of the catalyst metal or in a form of carrying no catalyst metal. At this time, for example, even if the air-to-fuel ratio of the exhaust gas varies due to traveling conditions of vehicles, a stable, excellent catalytic performance can be achieved.

The catalyst layer 20 may contain an alkaline earth element such as calcium (Ca) and barium (Ba). The alkaline earth element can reduce poisoning of the catalyst metal (particularly, the oxidation catalyst). Further, the alkaline earth element also enhances dispersibility of the catalyst metal and reduces sintering associated with grain growth of the catalyst metal. When the catalyst layer 20 contains an alkaline earth element in addition to the OSC material, the amount of oxygen absorbed by the OSC material can be further improved in a lean atmosphere (oxygen-rich atmosphere) where the fuel is lower than the theoretical air-to-fuel ratio. The alkaline earth element is contained in the form of oxide, hydroxide, carbonate, nitrate, sulfate, phosphate, acetate, formate, oxalate, or halide.

The catalyst layer 20 may further contain an NOx absorption material having an NOx storage capacity, a stabilizing agent, and the like. Examples of the stabilizing agent include rare-earth elements such as yttrium (Y), lanthanum (La), and neodymium (Nd). It should be noted that the rare-earth element which is present in the catalyst layer 20 is typically in a form of oxide.

Yet another example of the optional component in the catalyst layer 20 includes binders such as aluminum sol and silica sol, and various additives. The binder is preferably free from Si, and thus alumina sol is preferred.

Although not particularly limited thereto, the coating amount (formation amount) of the catalyst layer 20 may be approximately 30 g/L or more, typically 50 g/L or more, preferably 70 g/L or more, for example, 100 g/L or more, and may be approximately 500 g/L or less, typically 400 g/L or less, for example, 300 g/L or less, per 1 L of the volume of the exhaust gas purification catalyst 10 (volume of the base material 11). The coating amount in the above-described range can achieve both the improvement in purifying performance and the reduction in pressure drop at high level. It should be noted that the “coating amount” herein refers to the mass of solids contained per unit volume of the exhaust gas purification catalyst 10.

The length and the thickness of the catalyst layer 20 can be designed, as appropriate, according to the size of the cells 12 of the base material 11, the flow rate of exhaust gas flowing through the exhaust gas purification catalyst 10, and the like. The catalyst layer 20 may be provided continuously or intermittently on the partitions 14 of the base material 11. The catalyst layer 20 may be provided along the cylinder axis direction X from the inlet 10a for exhaust gas, or along the cylinder axis direction X from the outlet 10b for exhaust gas, for example.

Although not particularly limited thereto, the coating width (average length) of the entire catalyst layer 20 in the cylinder axis direction X is approximately 20% or more, preferably 50% or more, typically 80% or more, for example, 90% or more of the full length L of the base material 11, and may be the same length as the full length L of the base material 11. Although not particularly limited thereto, the coating thickness (average thickness) of the catalyst layer 20 is approximately 1 μm to 300 μm, typically 5 μm to 200 μm, for example, 10 μm to 100 μm. This can achieve both the improvement in purifying performance and the reduction in pressure drop at high level.

Portion of the catalyst layer 20 may have different composition from the other portion of the catalyst layer 20. For example, an upstream side X1 portion (front portion) and a downstream side X2 portion (rear portion) in the cylinder axis direction X of the catalyst layer 20 may have different compositions. Specifically, for example, the upstream side X1 portion (front portion) and the downstream side X2 portion (rear portion) in the cylinder axis direction X of the catalyst layer 20 may contain different catalyst metals.

The exhaust gas purification catalyst 10 illustrated in FIG. 3 has one catalyst layer 20 as a layer. However, the exhaust gas purification catalyst 10 may further have a layer other than the catalyst layer 20. When the exhaust gas purification catalyst 10 has multiple layers, at least one of them may satisfy the configuration of the catalyst layer 20. The layer other than the catalyst layer 20 can be, for example, a layer containing a catalyst metal but containing no HC adsorption material or a layer containing no catalyst metal. For example, the exhaust gas purification catalyst 10 includes a catalyst layer 20 in the upstream side X1 portion in the cylinder axis direction X of the base material, and a layer other than the catalyst layer 20 in the downstream side X2 portion. Alternatively, the exhaust gas purification catalyst 10 may have a layer other than the catalyst layer 20, above or below the catalyst layer 20.

The catalyst layer 20 of the exhaust gas purification catalyst 10 shown in FIG. 3 has a monolayer structure. However, the catalyst layer 20 may have a multilayer structure in which each layer contains a catalyst metal and an HC adsorption material. The following describes an example of an exhaust gas purification catalyst having a catalyst layer 20 which has a multilayer structure.

### Variation of Exhaust Gas Purification Catalyst 10

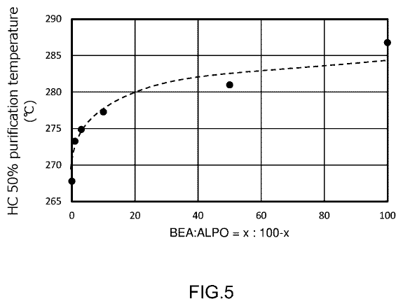

FIG. 4 is a schematic partial cross-sectional view of a portion of an exhaust gas purification catalyst 10′ which is a variation of the exhaust gas purification catalyst 10, cut along the cylinder axis direction X. The exhaust gas purification catalyst 10′ includes a base material 11, and a catalyst layer 20′ having a multilayer structure, provided on the base material 11. Since the catalyst layer 20′ has a multilayer structure, the exhaust gas purification performance can be further enhanced.

The base material 11 is the same as described above. The catalyst layer 20′ has a multilayer structure unlike the example shown in FIG. 3. Specifically, the catalyst layer 20′ has a multilayer structure in which a first portion catalyst layer (lower layer) 21 and a second portion catalyst layer (upper layer) 22 are stacked in the thickness direction. Thus, the lower layer 21 is provided to come into contact with the surface of the base material 11, and the upper layer 22 is provided to come into contact with the upper surface of the lower layer 21. In the example shown in FIG. 4, the catalyst layer 20′ has a two-layer structure, but may have a lamination structure of three or more layers. For example, the catalyst layer 20′ may have an intermediate layer between the lower layer 21 and the upper layer 22, or another layer on the upper layer 22.

The lower layer 21 and the upper layer 22 each contain the catalyst metal and the HC adsorption material. The lower layer 21 and the upper layer 22 may contain the same catalyst metal or different catalyst metals, and contain preferably different catalyst metals.

Specifically, for example, the lower layer 21 contains an oxidation catalyst (e.g., at least one of Pd or Pt) as a catalyst metal, and the upper layer 22 contains a reduction catalyst (e.g., Rh) as a catalyst metal. In such a case, the exhaust gas purification catalyst 10′ has a particularly excellent exhaust gas purification performance. In light of higher exhaust gas purification performance, it is advantageous that the catalyst metal of the lower layer 21 is Pt, and the catalyst metal of the upper layer 22 is Rh. Such a case is particularly advantageous for paraffin purification. Alternatively, in light of higher exhaust gas purification performance, it is advantageous that the catalyst metal of the lower layer 21 is Pd, and the catalyst metal of the upper layer 22 is Rh. Such a case is particularly advantageous for olefin purification.

It should be noted that when the lower layer 21 contains Pt, the lower layer 21 contains preferably 80 mass % or more, more preferably 90 mass % or more, yet more preferably 95 mass % or more, most preferably 100 mass % or more of Pt in the catalyst metal contained in the lower layer 21. When the lower layer 21 contains Pd, the lower layer 21 contains preferably 80 mass % or more, more preferably 90 mass % or more, yet more preferably 95 mass % or more, most preferably 100 mass % or more of Pd in the catalyst metal contained in the lower layer 21. When the upper layer 22 contains Rh, the upper layer 22 contains preferably 80 mass % or more, more preferably 90 mass % or more, yet more preferably 95 mass % or more, most preferably 100 mass % or more of Rh in the catalyst metal contained in the upper layer 22.

The lower layer 21 and the upper layer 22 may contain the same HC adsorption material or different HC adsorption materials. For example, the lower layer 21 and the upper layer 22 may contain ALPO molecular sieves having different framework structures as the HC adsorption material, respectively.

The lower layer 21 and the upper layer 22 may contain the same optional components as in the catalyst layer 20 described above.

### Method for Producing Exhaust Gas Purification Catalyst 10

The exhaust gas purification catalyst 10 can be produced by the following method, for example. First, a base material 11 and a catalyst layer forming slurry for forming a catalyst layer 20 are prepared. The catalyst layer forming slurry can be prepared by, for example, blending a catalyst metal source (e.g., a solution containing a catalyst metal as ions) and an HC absorbing material of essential raw material components, and other optional components (e.g., a non-OSC material, an OSC material, a binder, and various additives) in a dispersion medium. As the dispersion medium, for example, water, a mixture of water and water-soluble organic solvent can be used. Properties of the slurry, (e.g., the viscosity, the solid content, and the like of the slurry) can be determined, as appropriate, according to the size of the base material 11 used, the mode of the cells 12 (partitions 14), required characteristics of the catalyst layer 20, and the like.

Next, the catalyst layer forming slurry is used to form the catalyst layer 20 on the base material 11. The catalyst layer 20 may be formed by a known method (e.g., impregnation method, wash-coat method). Specifically, for example, the prepared catalyst layer forming slurry is allowed to flow into cells 12 from an end of the base material 11 to reach a predetermined length along the cylinder axis direction X. The slurry may be supplied from either the inlet 10a or the outlet 10b. In this stage, the excessive amount of the slurry may be sucked from the opposite end. Alternatively, the excessive amount of the slurry may be discharged from the cells 12 by blowing air from the opposite end, and the like. Thereafter, the base material 11 supplied with the slurry is dried and fired at a predetermined temperature for a predetermined time. The firing method may be the same as known ones. The drying may be performed before the firing so as to remove the dispersion medium. Thus, the raw material components are sintered on the base material 11, whereby a porous catalyst layer 20 is formed on the base material 11. The exhaust gas purification catalyst 10 can be obtained in the manner described above.

### Application of Exhaust Gas Purification Catalyst 10

The exhaust gas purification catalyst 10 can be suitably used to purify exhaust gas exhausted from internal combustion engines of vehicles such as cars and trucks, motorcycles and motorized bicycles, marine products such as ships, tankers, water bikes, personal watercraft, outboard motors, gardening products such as mowers, chainsaws, and trimmers, leisure products such as golf carts and four wheel buggies, power generation facilities such as cogeneration systems, and waste incinerators. Among them, the exhaust gas purification catalyst 10 is suitably applicable to vehicles such as cars, and especially vehicles including gasoline engines.

Some test examples regarding the present invention will be described below. However, it is not intended that the present invention is limited to such test examples.

### Example 1

As a base material, honeycomb base material (made of cordierite, volumetric capacity: 0.0175 L, full length: 24 mm, the number of cells: 400, cell shape: quadrangle, partition thickness: 6 mil) was provided. In addition, the following raw materials for a catalyst layer were prepared.
Catalyst metal source: aqueous nitrate-based Pt solution (for lower layer), aqueous Rh nitrate solution (for upper layer)
Non-OSC material: La₂O₃-composited Al₂O₃ with La₂O₃ content of 1 mass % to 10 mass % OSC material: CeO₂—ZrO₂ composite oxide with CeO₂ content of 15 mass % to 40 mass %, and trace amounts of Pd₂O₃, Nd₂O₃, La₂O₃, and Y₂O₃, subjected to treatment for high thermal resistance.
HC adsorption material: AFI-type ALPO-5

The aqueous nitrate-based Pt solution, La₂O₃-composited Al₂O₃, the CeO₂—ZrO₂ composite oxide, AFI-type ALPO-5, Ba sulfate, an Al₂O₃-based binder, and an aqueous solvent were blended to prepare a lower layer forming slurry. The lower layer forming slurry was then poured into the base material, and unwanted portion of the lower layer forming slurry was blown away by a blower, thereby coating the surface of the base material with a lower layer forming material. Water was removed from the resultant in a ventilated dryer set at 120° C., and the resultant was then fired at 500° C. for 1 hour. Thus, a lower layer containing a Pt catalyst was formed on the base material.

The aqueous Rh nitrate solution, La₂O₃composited Al₂O₃, the CeO₂—ZrO₂ composite oxide, AFI-type ALPO-5, an Al₂O₃-based binder, and an aqueous solvent were blended to prepare an upper layer forming slurry. The upper layer forming slurry was then poured into the base material on which the lower layer had been formed, and unwanted portion of the upper layer forming slurry was blown away by a blower, thereby coating the surface of the lower layer formed on the base material with an upper layer forming material. Water was removed from the resultant in a ventilated dryer set at 120° C., and the resultant was then fired at 500° C. for 1 hour. Thus, an upper layer containing a Rh catalyst was formed on the lower layer, and an exhaust gas purification catalyst of Example 1 was thereby obtained. In the obtained exhaust gas purification catalyst, the Pt content was 0.3 g/L, the Rh content was 0.06 g/L, the carrier (non-OSC material+OSC material) content was 146 g/L, the HC adsorption material content was 30 g/L per 1 L of the volume of the base material.

### Example 2

An exhaust gas purification catalyst of Example 2 was produced in the same manner as in Example 1 except that a mixture of AFI-type ALPO-5 and BEA-type zeolite (SiO₂/Al₂O₃ ratio=500) at a mass ratio of 99:1 was used as an HC adsorption material.

### Example 3

An exhaust gas purification catalyst of Example 3 was produced in the same manner as in Example 1 except that a mixture of AFI-type ALPO-5 and BEA-type zeolite (SiO₂/Al₂O₃ ratio=40) at a mass ratio of 97:3 was used as an HC adsorption material.

### Example 4

An exhaust gas purification catalyst of Example 3 was produced in the same manner as in Example 1 except that a mixture of AFI-type ALPO-5 and BEA-type zeolite (SiO₂/Al₂O₃ ratio=40) at a mass ratio of 90:10 was used as an HC adsorption material.

### Comparative Example 1

An exhaust gas purification catalyst of Comparative Example 1 was produced in the same manner as in Example 1 except that a mixture of ALPO-5 and BEA-type zeolite (SiO₂/Al₂O₃ ratio=500) at a mass ratio of 50:50 was used as an HC adsorption material.

### Comparative Example 2

An exhaust gas purification catalyst of Comparative Example 2 was produced in the same manner as in Example 1 except that BEA-type zeolite (SiO₂/Al₂O₃ ratio=500) was used instead of ALPO-5 as an HC adsorption material.

### Hydrothermal Durability Treatment

Rich gas and Lean gas were alternately distributed into the exhaust gas purification catalysts of Examples and Comparative Examples at 900° C. for 10 hours, switching every 10 minutes. The composition of the Rich gas was CO: 5%, water: 10%, and N₂: the balance. The composition of the Lean gas was O₂: 2.5%, water: 10%, and N₂: the balance.

### Catalyst Activity Evaluation for HC

While the pretreatment gas was distributed into the exhaust gas purification catalysts of Examples and Comparative Examples which had been subjected to the hydrothermal durability treatment, the temperature was increased from 100° C. to 500° C. at 20° C./min and held at 500° C. for 5 min. Then, while inactive gas (N₂ gas) was distributed into the exhaust gas purification catalysts, the temperature was lowered to 100° C. After the temperature has stabilized, the temperature was increased at 50° C./min while reaction gas is distributed into the exhaust gas purification catalysts, and the temperature at which the HC purification rate of the reaction gas reached 50% (HC 50% purification temperature: T50) was determined. The following pretreatment and reaction gases were used. FIG. 5 shows a graph of plots of the HC 50% purification temperatures of Examples and Comparative Examples.

### Pretreatment Gas

A/F ratio: 14.6;
C₃H₆: 2400 ppmC, C₃H₈: 600 ppmC, CO: 0.5%, NO: 800 ppm, H₂O: 10%, CO₂: 10%, O₂: 0.3%, N₂: the balance

### Reaction Gas

A/F ratio: 14.6;
C₃H₆: 1500 ppmC, C₁₀H₂₂: 1500 ppmC, H₂O: 3%, CO₂: 10%, O₂: 0.3%, N₂: the balance

As can be seen from the graph of FIG. 5, as the content of ALPO-5 (i.e., the molecular sieve substantially free from Si) in the HC adsorption material increases, the HC 50% purification temperature decreases, i.e., the HC purifying performance at cold start increases. When the content of ALPO-5 in the HC purifying performance reaches 80 mass % or more, the HC purifying performance drastically improves. As can be seen from the result, according to the exhaust gas purification performance disclosed herein, excellent exhaust gas purification performance at cold start after the hydrothermal durability treatment can be obtained.

### Example 5

An exhaust gas purification catalyst of Example 5 was produced in the same manner as in Example 1, except that aqueous nitrate-based Pd solution was used instead of the aqueous nitrate-based Pt solution as a catalyst metal source for lower layer. The hydrothermal durability treatment and the catalytic activity evaluation for HC were performed on the exhaust gas purification catalyst of Example 5 in the same manner as described above. The HC 50% purification temperature was 254.60° C., which was significantly low.

As can be seen from the result, the exhaust gas purification performance at cold start after the hydrothermal durability treatment can be obtained even when the catalyst metal species for the exhaust gas purification catalyst was changed. In other words, it can be seen that by allowing the hydrocarbon adsorption material to contain therein 80 mass % or more of molecular sieve substantially free from Si, the exhaust gas purification performance can be obtained.

It should be noted that the HC 50% purification temperature was lower when the catalyst metal for lower layer was Pd than Pt. The reasons for this may be as follows. The concentration ratio between olefin and paraffin in the reaction gas used was 1:1, and olefin generally has a higher 50% purification temperature than paraffin. Pd has better olefin purification performance than Pt, so that olefin can be purified more effectively and the decrease in HC 50% purification temperature was greater.

While some embodiments of the present invention have been described above, the embodiments are mere examples. The present invention can be implemented in various other embodiments. The present invention can be implemented based on the contents disclosed herein and the technical knowledge in the present field. The technology described is the appended claims include various modifications and changes of the foregoing embodiments. For example, it is possible to replace partially the embodiments with other aspects, and it is also possible to add other variations to the embodiments. If the technical feature is not described as essential, it can be eliminated, as appropriate.

1. An exhaust gas purification catalyst comprising:
a base material; and
a catalyst layer provided on the base material, wherein
the catalyst layer includes a catalyst metal and a hydrocarbon adsorption material, and
the hydrocarbon adsorption material contains 80 mass % or more of molecular sieve substantially free from Si.

2. The exhaust gas purification catalyst according to claim 1, wherein
the hydrocarbon adsorption material contains 90 mass % or more of the molecular sieve substantially free from Si.

3. The exhaust gas purification catalyst according to claim 1, wherein
the molecular sieve substantially free from Si is an aluminophosphate molecular sieve.

4. The exhaust gas purification catalyst according to claim 3, wherein
the aluminophosphate molecular sieve has a framework structure of AFI type.

5. The exhaust gas purification catalyst according to claim 1, wherein
the catalyst layer includes:
a first portion catalyst layer formed on a surface of the base material and including the catalyst metal; and
a second portion catalyst layer formed on the first portion catalyst layer and including the catalyst metal being different in type from the catalyst metal of the first portion catalyst layer,
the first portion catalyst layer includes, as the catalyst metal, an oxidation catalyst,
the second portion catalyst layer includes, as the catalyst metal, a reduction catalyst.

6. The exhaust gas purification catalyst according to claim 5, wherein
the first portion catalyst layer includes, as the catalyst metal, Pt, and the second portion catalyst layer includes, as the catalyst metal, Rh.

7. The exhaust gas purification catalyst according to claim 5, wherein
the first portion catalyst layer includes, as the catalyst metal, Pd, and the second portion catalyst layer includes, as the catalyst metal, Rh.

8. The exhaust gas purification catalyst according to claim 2, wherein
the molecular sieve substantially free from Si is an aluminophosphate molecular sieve.

9. The exhaust gas purification catalyst according to claim 2, wherein
the catalyst layer includes:
a first portion catalyst layer formed on a surface of the base material and including the catalyst metal; and
a second portion catalyst layer formed on the first portion catalyst layer and including the catalyst metal being different in type from the catalyst metal of the first portion catalyst layer,
the first portion catalyst layer includes, as the catalyst metal, an oxidation catalyst,
the second portion catalyst layer includes, as the catalyst metal, a reduction catalyst.

10. The exhaust gas purification catalyst according to claim 2, wherein
the catalyst layer includes:
a first portion catalyst layer formed on a surface of the base material and including the catalyst metal; and
a second portion catalyst layer formed on the first portion catalyst layer and including the catalyst metal being different in type from the catalyst metal of the first portion catalyst layer,
the first portion catalyst layer includes, as the catalyst metal, an oxidation catalyst,
the second portion catalyst layer includes, as the catalyst metal, a reduction catalyst.

11. The exhaust gas purification catalyst according to claim 3, wherein
the catalyst layer includes:
a first portion catalyst layer formed on a surface of the base material and including the catalyst metal; and
a second portion catalyst layer formed on the first portion catalyst layer and including the catalyst metal being different in type from the catalyst metal of the first portion catalyst layer,
the first portion catalyst layer includes, as the catalyst metal, an oxidation catalyst,
the second portion catalyst layer includes, as the catalyst metal, a reduction catalyst.

12. The exhaust gas purification catalyst according to claim 4, wherein
the catalyst layer includes:
a first portion catalyst layer formed on a surface of the base material and including the catalyst metal; and
a second portion catalyst layer formed on the first portion catalyst layer and including the catalyst metal being different in type from the catalyst metal of the first portion catalyst layer,
the first portion catalyst layer includes, as the catalyst metal, an oxidation catalyst,
the second portion catalyst layer includes, as the catalyst metal, a reduction catalyst.

13. The exhaust gas purification catalyst according to claim 8, wherein
the aluminophosphate molecular sieve has a framework structure of AFI type.
